(19) United States
(12) Patent Application Publication
(10) Pub. No.: US 2003/0186128 A1
(43) Pub. Date: Oct. 2, 2003

(54) Lithium-based rechargeable batteries

(76) Inventors: Deepika Singh, Gainesville, FL (US); Rajiv K. Singh, Gainesville, FL (US)

Correspondence Address: AKERMAN SENTERFITT, P.O. BOX 3188, WEST PALM BEACH, FL, 33402-3188, US

(21) Appl. No.: 10/397,583

(22) Filed: Mar. 26, 2003

Related U.S. Application Data
(60) Provisional application No. 60/368,869, filed on Mar. 29, 2002.

(51) Int. Cl. H01M 4/48; H01M 4/50; H01M 10/40; C01G 45/12

(52) U.S. Cl. 429/231.1; 429/224; 429/306; 252/182.1; 423/599

(57) ABSTRACT

A cathode composition for lithium ion and lithium metal batteries includes a transitional metal oxide, the transitional metal oxide comprising a plurality of compositionally defective crystals. The defective crystals have an enhanced oxygen content as compared to a bulk equilibrium counterpart crystal. An oxygen-rich lithium manganese oxide composition can provide an improved cathode which allows formation of rechargeable batteries having enhanced characteristics. Cathodes can exhibit high capacity (>150 mAh/gm), long cycle life (less than 0.05% capacity loss per cycle for 700 cycles), and high discharge rates (>25 C for a 25% capacity loss).

### CROSS-REFERENCE TO RELATED APPLICATION

This application claims the benefit of U.S. Provisional Application No. 60/368,869 entitled NOVEL SYNTHESIS METHOD AND COMPOSITION OF HIGH CAPACITY, LONG CYCLE LIFE AND HIGH DISCHARGE RATE LITHIUM BASED RECHARGEABLE BATTERIES, filed on Mar. 29, 2002, the entirety of which is incorporated herein by reference.

### STATEMENT REGARDING FEDERALLY SPONSORED RESEARCH OR DEVELOPMENT

Not applicable.

### FIELD OF INVENTION

The present invention relates to improved cathode materials for primary and secondary lithium batteries.

### BACKGROUND OF THE INVENTION

The demand for new and improved electronic devices such as cellular phones and notebook computers have demanded energy storage devices having increasingly higher specific energy densities. A number of advanced battery technologies have recently been developed to service these devices, such as metal hydride (e.g., Ni-MH), nickel-cadmium (NiCd), lithium batteries with liquid electrolytes and more recently, lithium batteries with polymer electrolytes.

Lithium batteries have been introduced into the market because of their high energy densities. Lithium is atomic number three (3) on the periodic table of elements, having the lightest atomic weight and highest energy density of any room temperature solid element. As a result, lithium is a preferred material for batteries. Lithium batteries are also desirable because they have a high unit cell voltage of up to approximately 4.2 V, as compared to approximately 1.5 V for both NiCd and NiMH cells.

Lithium batteries can be either lithium ion batteries or lithium metal batteries. Lithium ion batteries intercalate lithium ions in a host material, such as graphite, to form the anode. On the other hand, lithium metal batteries use metallic lithium or lithium metal alloys for the anode.

Substantial effort has recently been focused on improving specific rechargeable Li battery system characteristics, such as capacity, cycle life and discharge rate. The highest specific Li battery characteristics are obtained when a metallic lithium comprising anode, as opposed to a lithium ion anode, is used. However, the use of Li metal comprising anodes for secondary batteries has generally been limited by certain known technical challenges.

Selection of the cathode material can also significantly affect the specific Li battery characteristics obtained. Cathode materials that have been used for Li batteries include Fe(PO₄)₃, MnO₂, VₓO_{y}, LiₓMn_{y}O_{z}, LiNiO₂, TiS₂ and more commonly LiCoO₂.

Substantial efforts have been focused on replacing the conventional LiCoO₂ cathodes with cheaper, safer and more environmentally acceptable materials such as LiₓMn_{y}O_{z} compounds, specifically LiMn₂O₄ and its related compounds. A LiMn₂O₄ unit cell has a space group corresponding to Fd₃m symmetry. The structure of the spinel LiMn₂O₄ consists of a cubic close-packed oxygen array. The lithium ions are located at the “8a” tetragonal sites, the manganese ions are located at the “16d” octahedral sites and the oxygen ions are located at the “32e” positions. The lattice constant of the LiMn₂O₄ unit cell is 8.247 Å. A summary of the atomic positions in the LiMn₂O₄ unit cell lattice is shown below in Table 1.

TABLE 1
Occupation of cations in the lattice of LiMn₂O₄.

| Species | Site | x/a | y/a | z/a |
|---|---|---|---|---|
| Li | 8a | 0 | 0 | 0 |
| Mn | 16d | 0.625 | 0.625 | 0.625 |
| O | 32e | 0.3886 | 0.3886 | 0.3886 |

The free space in the Mn₂O₄ framework is a d-type network with 8a tetrahedral and 16c octahedral sites. These empty sites are interconnected together by common faces and edges to form a three-dimensional pathway for Li⁺ ion diffusion.

The electrochemical behavior of bulk LiMn₂O₄ electrode is known to depend strongly on the processing conditions to form this material, such as temperature, initial Li:Mn ratio, oxygen pressure and cooling rates. This is due to the existence of a wide range of possible spinel Li—Mn—O compounds. The spinel phase of LiMn₂O₄ is located in the LiMn₂O₄—Li₄Mn₅O₁₂—Li₂Mn₄O₉ triangle as shown in FIG. 1.

The stoichiometric spinel is usually defined as LiMn₂O₄ and non-stoichiometric spinels are defined as “Lithium-rich” or “vacancy-rich” compounds. Such non-stoichiometry can be achieved by replacing some of the manganese in the “16d” sites of the cubic spinel by an ion of a lower valance. Lithium is particularly favored because it introduces no new ions into the system Li₁₊ₓMn₂₋ₓO₄ (0≦x≦0.33). When Mn is partially substituted by Li in the octahedral sites the compounds are termed as “lithium-rich” compounds. Alternatively, cation deficient spinels such as Li₁₋ₓMn₂₋₂ₓO₄ (0≦x≦0.11) can be prepared which have been termed as “vacancy-rich” compounds. Li₄Mn₅O₁₂ is the limiting compound of the lithium-rich series and Li₂Mn₄O₉ of the vacancy-rich series for a 4 V cathode.

The term “defective spinel phase” refers to compositionally defective materials as well as structurally defective materials. Non-stoichiometric materials which have been previously discussed in earlier sections as being “lithium-rich” or the “vacancy-rich” compounds are examples of compositionally defective materials. Structurally defective spinels include materials which have significant crystalline imperfections, such as slightly amorphous materials.

Studies have suggested that the electrochemical behavior is sensitive to morphological characteristics such as particle size and surface area. This indicates that the electrochemical properties are also related to the compound structure.

A decrease in capacity with increasing Li/Mn molar ratio or vacancy rate in the spinel is known. Cycling stability is generally improved for an increase in lithium doping. This can be explained by the decrease in the change of lattice constant upon cycling. This indicates that large capacity and good rechargeability are not common to spinel structure electrode materials. For example, for many spinels with a Li/Mn ratio of 0.55, the capacity may be limited to 120 mAH/g.

In the LiMn₂O₄ phase, the extraction of a Li ion from the tetrahedral sites takes place in two closely spaced steps at approximately 3.9˜4.2 V vs. Li/Li⁺ (LiMn₂O₄→Mn₂O₄ (λ-MnO₂)), whereas the insertion of a Li⁺ ion into the octahedral sites occurs at approximately 3 V vs. Li/Li⁺ (LiMn₂O₄→Li₂Mn₂O₄). The insertion of lithium into LiMn₂O₄ is naturally accompanied by a reduction in the average oxidation state of manganese from 3.5 to 3. The presence of more than 50% of Jahn-Teller ions (Mn₃⁺) in host structures introduces a cubic to tetragonal distortion (from c/a=1 to c/a=1.16), which upon repeated cycles is believed to deteriorate the electrical contact and decrease the capacity of the cathode.

Thus, the maximum usable capacity of LiMn₂O₄ is limited to 0.5 Li atom per Mn atom which translates to the maximum useable capacities of 120˜140 mAh/gm. The cycle life (defined by 75% reduction in capacity) is typically in the range of 200 to 400 cycles, whereas the maximum discharge rate is limited by the diffusivity of lithium ions into the positive cathode. Intense efforts to simultaneously enhance the capacity, discharge rate and cycle life in the past decade have met with limited success. For example, high capacities (exceeding 200 mAh/gm) have been observed in nanocrystalline Li—Mn—O and LiMnO₂ materials. However, these materials have shown very low discharge rates or short cycle life. On the other hand, high discharge rate nanostructured cathode materials have provided total capacities that are typically not adequate for most applications.

Therefore, although several methods for forming LiMn₂O₄ based cathodes have been considered including composition and doping variations, formation of novel phases, and microstructural tailoring, none of the materials produced have provided high capacity, cycle life and discharge rate.

### SUMMARY OF THE INVENTION

A cathode composition for lithium ion and lithium metal batteries includes a transitional metal oxide, the transitional metal oxide comprising a plurality of compositionally defective crystals, the compositionally defective crystals having an enhanced oxygen content as compared to a bulk equilibrium counterpart crystal. The transitional metal oxide can include lithium manganese oxide or lithium manganese oxide doped with one or more elements. These doping elements can include Al, Cr, Co, Ni, Mg, Ti, Ga, Fe, Ca, V and Nb. The ratio of lithium to manganese can be substantially stoichiometric.

The term “bulk equilibrium counterpart crystal” as used herein refers to a stoichiometric crystal phase which is generally formed under equilibrium process conditions, such as LiMn₂O₄, or formed upon appropriately heating certain compositionally defective crystals, such as heating the oxygen rich defective crystal formed using the invention to at least a transition threshold of temperature of about 700° C. for most oxygen-rich LiMnO materials formed. The compositionally enhanced defective crystals can be in the form of a film with a thickness varying from 50 nanometer to 1 mm or in the form of powders having plurality of particles with particle sizes varying from about 5 nm to 100 microns.

The transitional metal oxide can comprise Li_{1-δ}Mn_{2-2δ}O₄, wherein 0<_{δ}<1. The capacity of the cathode composition can be at least 150 mAh/gm. The cathode composition can provide a Li ion diffusivity of at least 2×10⁻¹⁰ cm²/sec at 25° C. Cathodes formed using the invention also provide long cycle life (less than 0.05% capacity loss per cycle for at least 300 and more preferably at least 700 cycles), and high discharge rates (>25 C-rate for a 25% capacity loss). The usable capacity of cathode material described herein can extend beyond about 1.5 V to 4.5 V.

A method of forming cathode material for lithium ion and lithium metal batteries includes the steps of providing a reactive oxygen containing atmosphere, the reactive oxygen containing atmosphere comprising at least one oxygen containing species having a reactivity greater than O₂, and ablating a transitional metal oxide material from a transitional metal containing target. A plurality of compositionally defective crystals are formed, the crystals having an enhanced oxygen content as compared to the target. The step of providing a reactive oxygen containing atmosphere can comprise supplying O₂ and applying energy to the O₂ to produce at least one oxygen containing molecule having a reactivity greater O₂, such as ozone or nitrous oxide. The energy can be provided by a UV lamp or a plasma source.

An electrochemical cell includes an anode comprising lithium ions or lithium metal, and a cathode, the cathode including a defective transitional metal oxide layer. An electrolyte is operatively associated with the anode and cathode. The electrolyte is preferably polymer-based. The electrochemical cell can be a primary or a rechargeable cell.

The defective transitional metal oxide layer has an enhanced oxygen content as compared as to a bulk transitional metal oxide film. The transitional metal oxide can be a lithium manganese oxide. The lithium manganese oxide can be doped and include at least one doping element (M) and have the formula Li₁₋ₓM_{y}Mn_{2-2z}O₄, where x, y and z vary from 0.0 to 0.5.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates a semi-quantitative Li—Mn—O phase diagram.

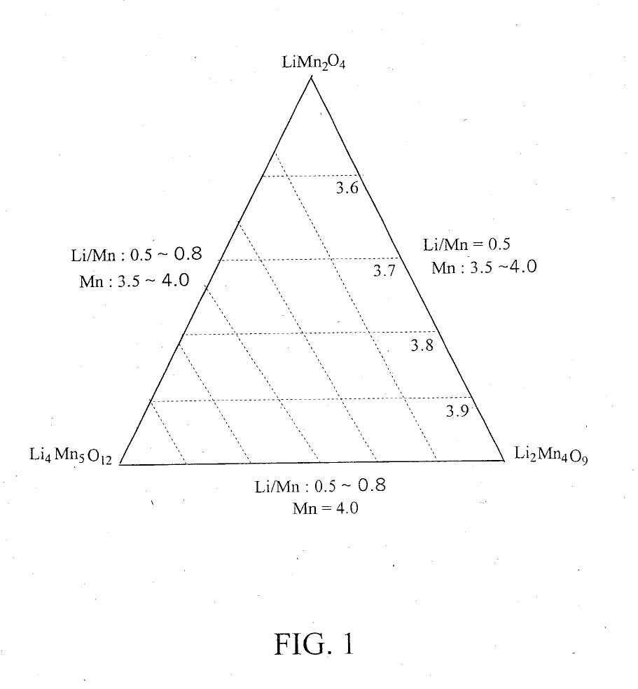

FIGS. 2(a) and (b) illustrate XRDs from lithium manganese oxide films deposited at 600° C. in an oxygen containing atmosphere using (a) pulsed laser deposition (PLD) and (b) ultraviolet assisted pulsed laser deposition (UVPLD).

FIG. 3 illustrates the lattice parameter of lithium manganese oxide films as a function of temperature.

FIG. 4 illustrates the cycle voltammogram of a Li_{1-δ}Mn₂₋₂₇O₄ film deposited by UVPLD.

FIG. 5 illustrates cycling behavior of Li_{1-δ}Mn_{2-2δ}O₄ (UVPLD) and LiMn₂O₄ (PLD) films deposited at 400° C.

FIG. 6 illustrates the relative capacity as a function of the discharge rate of Li_{1-δ}Mn_{2-2δ}O₄ (UVPLD) and LiMn₂O₄ (PLD) films deposited at 400° C.

FIG. 7 illustrates a schematic of the PLD system used for fabricating LiMn₂O₄ films.

### DETAILED DESCRIPTION OF THE INVENTION

A cathode composition for lithium ion and lithium metal batteries includes a transitional metal oxide, the transitional metal oxide comprising a plurality of compositionally defective crystals, the defective crystals having an enhanced oxygen content as compared to a bulk equilibrium counterpart crystal. The transitional metal oxide can include a lithium manganese oxide. In one preferred embodiment, the ratio of lithium to manganese in the cathode composition can be substantially stoichiometric. Other embodiments include addition of doping elements to the transitional metal oxide, varying the Li/Mn ratio by 50% or less from its stoichiometric value.

The compositionally enhanced defective crystals can be in form of a film with thickness varying from about 50 nanometers to 1 mm or in the form of powders having plurality of particles with particle sizes varying from about 5 nm to 100 microns.

To produce enhanced oxygen content in the crystals several techniques can be used such as ultraviolet oxidation of oxygen, oxygen based plasma processing using RF, microwave or a dc plasma, low temperature (e.g. <700° C.) thermal processing in an oxygen atmosphere, and ozonation of the surface. Thin film techniques, such as laser ablation, electron beam deposition and ion beam deposition, can also be used.

This invention can be used to deposit defective lithium-based manganospinel materials which have cycle lives >1000 cycles, possess 50% more usable capacity as compared to the ideal value of 148 mAh/gm available from conventional spinel electrodes, and exhibit an order of magnitude higher discharge rate than the state of the art cathode materials such LiMn₂O₄. The added capacity is primarily attributed to the large cycle life in both 4V and less than 3V regions, unlike conventional LiMn₂O₄ electrodes.

The defective spinel formed is characterized by a higher oxygen content than the equilibrium LiMn₂O₄ phase and has been successfully prepared using non-equilibrium based processes, such as an ultraviolet assisted pulsed laser deposition (UVPLD) technique. For a defective Li_{1-δ}Mn_{2-2δ}O₄ spinel phase, for example, δ can be from 0 to 1, but is preferably from 0 to 0.11.

If doping materials are used or the Li/Mn stoichiometry is varied, the value of delta (δ) can change to Li₁₋ₓM_{y}Mn_{2-2z}O₄, where M corresponds to doping elements such as Al, Cr, Co, Ni, Mg, Ti, Ga, Fe, Ca, V and Nb, while x, y and z can range from zero to 1. In a preferred embodiment x, y and z are from zero to 0.5.

Although not seeking to be bound by theory, the long cycle life and high capacity is believed to be attributed to the ability to cycle the Mn⁺ valence to be less than 3.5 without onset of Jahn-Teller structural transformation, while the high discharge rate is believed to be attributed to the extremely high diffusivity of Li⁺ in defective oxygen rich spinels, such as defective Li_{1-δ}Mn_{2-2δ}O₄, where δ is preferably ranges from 0 to 0.1 1.

A process for forming the cathode composition can include ablating, evaporating, sputtering from a transitional metal containing target or chemically reacting one or more reagents including an appropriate transitional metal containing species in a reactive oxygen containing atmosphere, the reactive oxygen containing atmosphere comprising at least one oxygen containing species having a reactivity greater than O₂.

Examples of species and methods for forming the same having a reactivity higher than O₂ include (1) ozone, such as formed by ozonation, (2) atomic oxygen, such as formed from O₂ using a radio frequency, dc or microwave plasma, (3) molecular oxygen and ozone (O₃) formed from O₂ subjected to ultraviolet light sources with wavelength less than about 200 nm, and (4) more reactive oxygen containing gases, such as nitrous oxide. These reactive species can be used during the fabrication of the oxide or annealing the oxide.

Conventional pulsed laser deposition techniques require high temperatures, such as 800° C. or more, during deposition to grow highly crystalline thin films. However, such high temperatures generally convert in-situ non-equilibrium phases formed into conventional equilibrium manganospinels, such as LiMn₂O₄. The invention prevents the transformation of the non-equilibrium manganospinels formed into conventional manganospinels by using a lower substrate temperature and a highly reactive oxygen species partial pressure without sacrificing the quality of deposited layer.

For example, a non-thermal energy source can be provided during the deposition process. Short wavelength UV radiation (λ<200 nm) can be used to dissociate molecular oxygen (O₂) and form ozone (O₃) and atomic oxygen, which serve as a more reactive gaseous species as compared to O₂. It is therefore expected that by using an energetic source capable of generating oxygen species more reactive as compared to diatomic oxygen, such as an in-situ UV source capable of dissociating molecular oxygen during the PLD process, significant improvement in the quality of layers produced, especially for low substrate temperatures can be obtained.

The UVPLD method has been used by the Inventors for the deposition of non-manganospinel oxides. For example, Y₂O₃ layers have been grown by a UV assisted PLD process at substrate temperatures ranging from 200° C. to 650° C.

The invention produces superior cathode materials by incorporating higher amounts of oxygen in the manganospinels at comparatively low processing temperatures, such as 650° C., or less. As a result, oxygen rich Li_{1δ}Mn_{2-2δ}O₄ phases are formed which lead to excellent rechargeable battery characteristics when cathodes formed from this material are used to form batteries. Traditional techniques to make such materials have failed because the high temperature processing (e.g. 800° C.) converts the phase formed into a conventional manganospinel, such as LiMn_{2-δ}O₄.

The invention includes several related methods for forming defective Li_{1-δ}Mn_{2-δ}O₄ manganospinels, which contain vacancies at both tetrahedral lithium sites and octahedral manganese sites. These materials can exhibit high capacity (>150 mAh/gm), high cycle life (>300 cycles) and high discharge-rates (>25 C-rate for a 25% capacity loss). Such compounds also are characterized by a Li/Mn ratio of 0.5 and have an average Mn⁺ valence state varying from 3.5 to 4.0 (depending on the value of δ). For a value of δ=0.11 this compound has a stoichiometric form of Li₂Mn₄O₉ with a Mn⁺ oxidation state of 4.0.

The higher the value of _{δ}, the lower the capacity at 4 V, the smaller the lattice parameter, and the better the cyclability in the 3 V region. Although it has been speculated that the oxygen-rich lithium manganospinels such as Li₂Mn₄O₉ can deliver high steady capacities in excess of 150 mAh/gm, the reproducible synthesis of fully oxidized single phase using a bulk solid state chemistry technique has been reported to be quite difficult. The term “fully oxidized” is understood to correspond to an initial Mn oxidation state of approximately 4.0. Strict control of the experimental conditions such as temperature, time, particle size and oxygen partial pressure have not led to production of fully oxidized phase material. Increased oxygen incorporation has particularly been difficult as higher processing temperature, such as 400° C., tends to revert the defective spinel back to stoichiometric LiMn₂O₄ phase. Thus, available thin film deposition techniques, which have typically been used, have not been successful in maintaining a constant stoichiometric Li/Mn ratio or enhancing the oxygen content further compared to their bulk counterparts.

In an embodiment of the invention, a method of forming cathode material for lithium ion and lithium metal batteries includes the steps of providing a reactive oxygen containing atmosphere, the reactive oxygen containing atmosphere comprising at least one oxygen containing species (e.g. O₃) having a reactivity greater than O₂, and ablating transitional metal oxide material from a transitional metal containing target. A plurality of defective crystals are formed, the crystals having an enhanced oxygen content as compared to the target.

In one embodiment of the method, ultraviolet assisted pulsed laser deposition (UVPLD) is used to synthesize Li_{1-δ}Mn_{2-2δ}O₄ films. The ultraviolet lamp generates reactive oxygen containing species (e.g. ozone) from a less reactive species, such as diatomic oxygen. For example, an ultraviolet lamp capable of emitting radiation at about 185 nm can be used for breaking the diatomic oxygen in the deposition chamber into atomic and other reactive species such as ozone. The enhanced reactivity of non-equilibrium oxygen species leads to formation of Li_{1-δ}Mn_{2-2δ}O₄ films during the UVPLD process.

It is also known that the pulsed laser deposition process helps to maintain the stoichiometry of the films primarily because of the rapid ablation process and the relatively high partial pressure of oxygen in the chamber. The use of an ultraviolet assisted deposition process can lead to enhanced oxygen incorporation in several oxide-based systems including Y₂O₃, ZrO₂, BaSrTiO₃, LaCaMnO₃, and related systems.

Rather than using an ultraviolet lamp to generate reactive oxygen containing species, other energy imparting sources, such as plasma sources, can be used. Alternatively, reactive oxygen containing species, such as ozone, may be supplied directly to the deposition chamber to obviate the need for an energetic source to convert diatomic oxygen to more reactive oxygen species. In these embodiments, the process can be characterized as pulsed laser ablation (PLD), as no ultraviolet source is required. Other means of enhancing the oxygen reactivity include (1) ozonation, (2) formation of atomic oxygen using a radio frequency, dc or microwave plasma, (3) using a ultraviolet light sources with wavelength less than about 200 nm, or (4) use of more reactive oxygen containing gases such as nitrous oxide. These sub-processes can be used during the fabrication of the oxide or during annealing of the oxide.

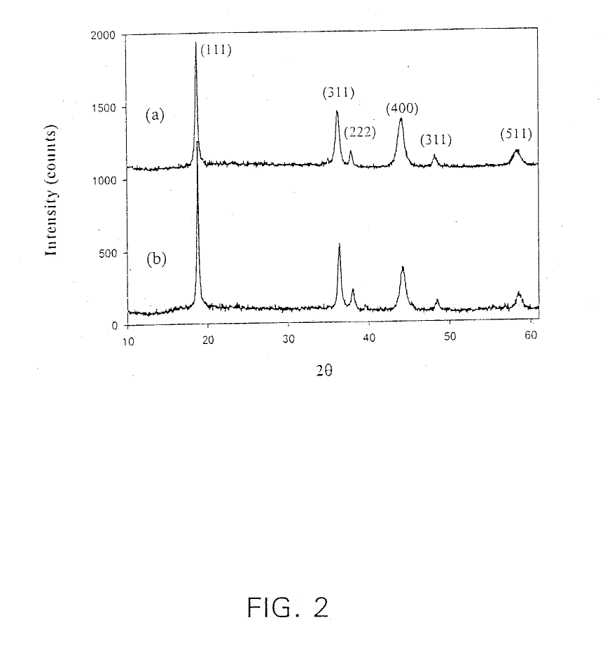

FIG. 2 compares X-ray diffraction (XRD) spectra from films deposited on silicon using pulsed laser deposition (PLD) as compared to UVPLD at the same processing temperature (600° C.) and oxygen pressure (1 mbar). The PLD process did not include a source for generating reactive oxygen containing species. FIG. 2 shows that the x-ray diffraction peaks are qualitatively quite similar for both spectra shown with the exception that the peaks in the UVPLD film are much sharper. Sharper peaks indicate a high degree of crystallinity.

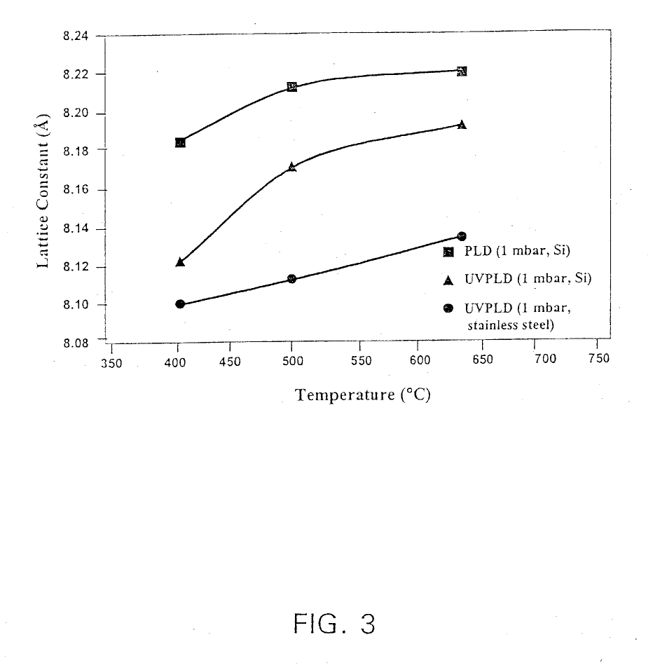

A more significant difference between these films that can be obtained from X-ray diffraction patterns is the variation in the lattice parameter as a function of processing temperature. The variation in the unit cell lattice parameter as a function of deposition temperature for layers deposited by PLD and UVPLD is shown in FIG. 3. This figure shows that the PLD films deposited on silicon have a lattice parameter in the range of 8.18 to 8.22 Å which corresponds to the lattice parameter range of the bulk equilibrium LiMn₂O₄ phase.

The films deposited on silicon and stainless steel by UVPLD under the same temperatures exhibit a much smaller lattice parameter when compared to PLD films. The Li/Mn ratio as measured by Nuclear Reaction Analysis and Rutherford Backscattering Spectroscopy was close to 0.5 for all films, the smaller lattice parameter evidencing the formation of the oxygen-rich Li_{1-δ}Mn_{2-2δ}O₄ spinel. For stress-free Li_{1-δ}Mn_{2-2δ}O₄ films, the lattice parameter can be used as a measure of _{δ}. However, using the invention process, the growth stress and thermal expansion mismatch effects can alter the lattice parameter.

Further confirmation of the Li_{1-δ}Mn_{2-2δ}O₄ phase was obtained from XPS studies which showed that the atomic concentration of Mn₄⁺/Mn₃⁺ and Mn/O were in the range of 1.5 to 3.0, and 2.1 to 2.3, respectively for UVPLD films. It is also noted that the lattice parameter of UVPLD films on the steel substrate is smaller than films deposited on silicon substrate likely because of the higher compressive stress generated in the films due to thermal expansion mismatch between the film and the substrate. If thermal expansion effects are considered (thermal expansion coefficient of Si=4×10⁻⁶/K and stainless steel=15×10⁻⁶/K), the lattice parameters of UVPLD films on silicon and stainless steel approximately match each other. Studies have suggested that oxygen-rich spinels are stable at temperature below 400° C. However, it is believed that the presence of atomic oxygen species during the UVPLD process may increase the stability temperature for Li_{1-δ}Mn_{2-2δ}O₄ phase to about 650° C.

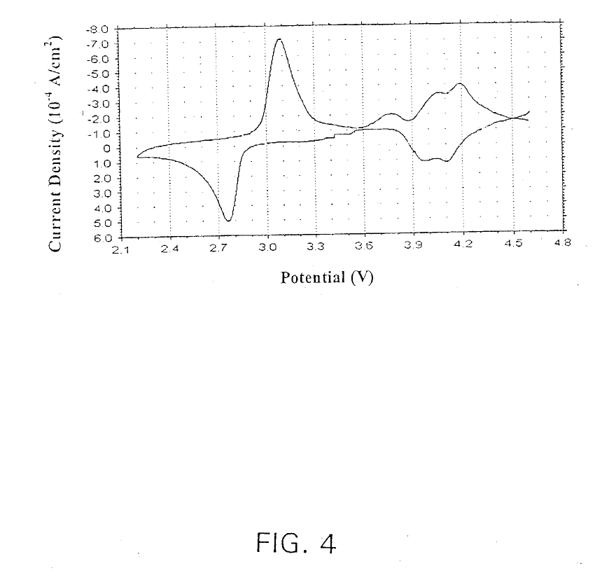

Extensive electrochemical and battery measurements were conducted using LiMn₂O₄ and Li_{1-δ}Mn_{2-2δ}O₄ films synthesized by PLD and UVPLD techniques, respectively. The electrochemical measurements were conducted in a coin cell configuration using a liquid electrolyte comprising 1M LiPF₆ salt in an EC-DMC solvent. The cyclic voltammogram from a Li/Li_{1-δ}Mn_{2-2δ}O₄ cell cycled from 2.2 V to 4.6 V is shown in the FIG. 4. The CV spectra show that the lithiation and delithiation reactions are reversible. For the defective spinel formed from the UVPLD process, during anodic scan lithium ions are inserted at approximately 3.1 V whereas the remaining lithium ions are inserted in a two-step processes at 4.05 and 4.19 V, respectively. The redox peaks were used to estimate the lithium ion diffusivity using the Randle-Sevick equation. Diffusivity values of 5.0×10⁻⁷ to 2×10⁻¹⁰ cm²/sec were obtained from Li_{1-δ}Mn_{2-2δ}O₄ films, which is 1 to 2 orders of magnitude higher than the diffusivity values obtained from conventional LiMn₂O₄ materials. It is also noted that unlike LiMn₂O₄ films, the 3 V capacity is much larger than the 4 V capacity which is characteristic of Li_{1-δ}Mn_{2-2δ}O₄ oxygen rich spinels.

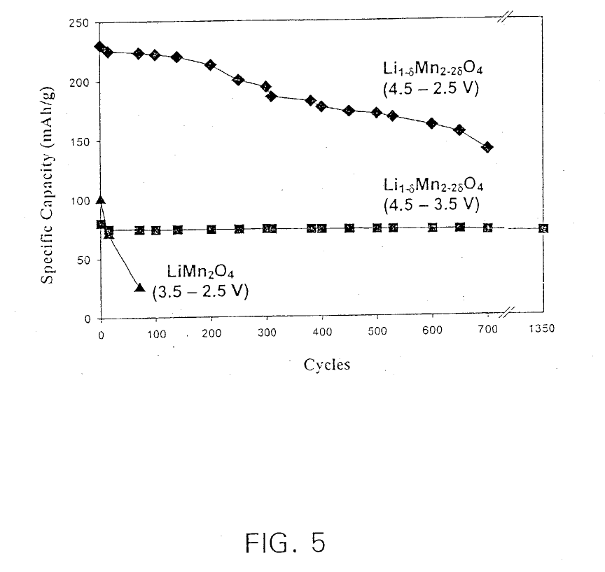

The capacity, cycle life and the maximum discharge rate capability were determined for Li_{1-δ}Mn_{2-2δ}O₄ films which were approximately 2.0 mm in thickness. FIG. 5 shows the cycle life of the Li_{1-δ}Mn_{2-2δ}O₄ films deposited on a steel substrate at 400° C. and 1 mbar oxygen pressure for films cycled in both 4 V (4.5 to 3.5 V) and 4 and 3 V (4.5˜2.5 V) ranges. For comparison, the cycling characteristics of LiMn₂O₄ films are also shown. These films were cycled at 1000 mA/cm² which corresponds to approximately a 10 C rate. The initial capacities of the Li_{1-δ}Mn_{2-2δ}O₄ films was approximately 80 mAh/gm and 230 mAh/gm when cycled in the 4.5-3.5 V and 4.5-2.5 V ranges, respectively.

Under extended cycling conditions in both these voltage ranges, excellent cycle life is obtained. In the 4 V range, less than 15% capacity loss is obtained when cycled for over 1300 cycles whereas in both 3 V and 4 V range, the capacity loss is approximately 30% when cycled to more than 700 cycles. In contrast, typical LiMn₂O₄ films exhibit very short cycle life as expected when subjected to 3 V cycling conditions.

The high capacity and excellent cycle life of Li_{1-δ}Mn_{2-2δ}O₄ thin film cathodes may be attributed to a number of factors. Relatively low cycle life in bulk LiMn₂O₄ electrodes has been attributed to the dissolution on Mn from the cathode, inhomogeneous local structure and Jahn-Teller transition which occurs when the average valence state of Mn in LiMn₂O₄ is 3.5. The results presented herein suggest that during 4 V cycles, the average valence of Mn in the films is less than 3.5. However, no significant degradation in the electrochemical characteristics were observed. The long cycle life due to specific thin film effects is believed to be attributed to (i) presence of compressive stresses, (ii) high film homogeneity and (iii) the formation of an oxygen rich Li_{1-δ}Mn_{2-2δ}O₄ phase. The films deposited on steel substrate have compressive strains of approximately 0.6% to 1% as indicated by the reduced lattice parameter. The compressive stresses may prevent the onset of the Jahn-Teller transition in these films. The films are very homogenous with strong grain boundary contact and lack of binder and conducting phases. These effects combined with a relatively highly defective structure of Li_{1-δ}Mn_{2-2δ}O₄ may prevent the onset of Jahn-Teller structural transition and better accommodate stress during cycling.

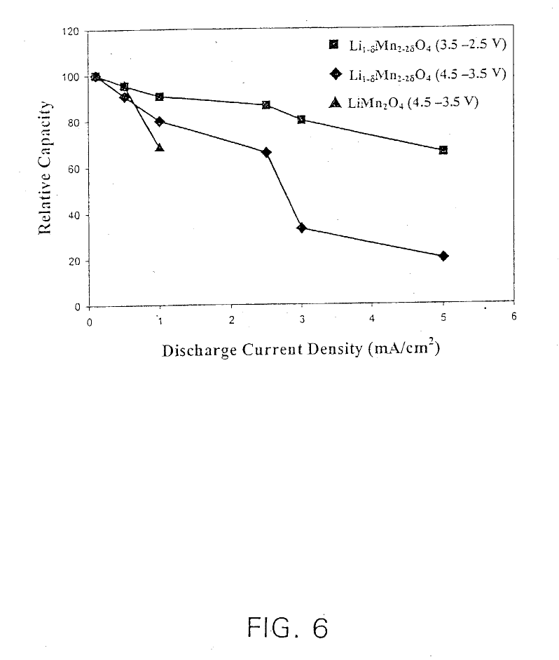

Another important characteristic of a battery is the effect of the discharge rate on the battery capacity. Reports have indicated that the LiMn₂O₄ and other related compounds are characterized by capacity losses when cycled at high rates. Experimental results obtained indicate that if the microstructure and the film thickness are carefully tailored, very high rate discharge capabilities are obtained. FIG. 6 shows the charging capacity as a function of the discharge rate for a 2.0 mm film deposited using UVPLD on steel substrate at 400° C. and 1 mbar of oxygen pressure. The films were discharged both in the 4 V and 3 V regions.

The figure shows that very high discharge rate capabilities are obtained from Li_{1-δ}Mn_{2-2δ}O₄ for both the 4 V and 3 V cycling. For example, at a discharge rate of 25 C, the capacity degradation is less than 25% in the 4 V and 3 V regions. Even at discharge rates of 50 C in the 3 V region, nearly 60% of the capacity is still available for use. In contrast, LiMn₂O₄ spinels show much higher capacity losses when discharged at high ‘C’ rates. The high rate discharge capability of Li_{1-δ}Mn_{2-2δ}O₄ can be attributed to rapid intercalation kinetics of the lithium ions in the Li_{1-δ}Mn_{2-2δ}O₄ films. The large number of vacancies in the 8a tetrahedral and 16_{δ} octahedral sites, combined with a large number of line defects such as grain boundaries may significantly enhance the Li⁺diffusion coefficient.

### EXAMPLES

### Example 1

### Pulsed Laser Deposition (PLD)

Fabrication of various LiₓMn₂O₄ thin films were performed in a vacuum chamber where a rotating bulk LiₓMn₂O₄ target was ablated by an incident KrF pulsed excimer laser emitting 25 ns pulses. The laser fluence was varied in the range of 1.0-2.0 J/cm² by varying the energy delivered by the laser. The substrate was mounted on the faceplate of a resistive substrate heater and placed parallel to the target surface. The substrate was heated to a temperature of 400 to 750° C. under vacuum.

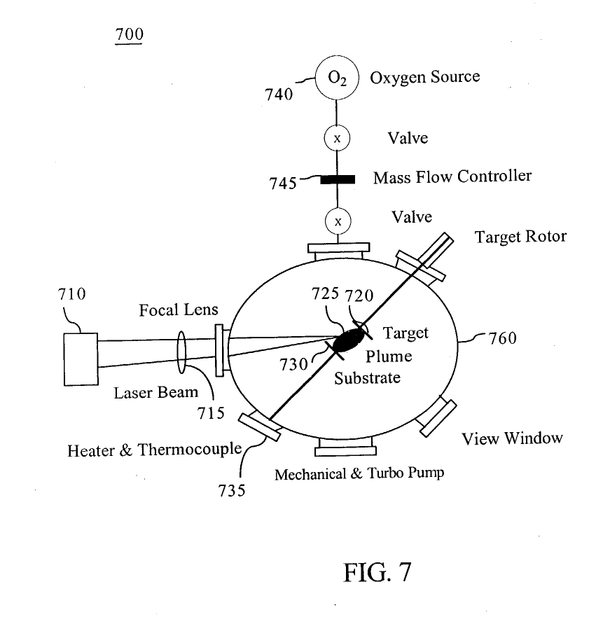

A schematic of the PLD system 700 including vacuum chamber 760 used for fabricating LiMn₂O₄ films is shown in FIG. 7. The system included a KrF excimer laser 710 for ablation which is focused by lens 715 before striking LiₓMn₂O₄target 720 to produce plume 725 which falls incident on substrate 730. The distance between the substrate 730 and target 720 was maintained at 5 cm because it has been reported that a large distance between the substrate 730 and target 720 can cause a loss of lithium in the stoichiometry of the film, while distances smaller than 5 cm can cause large particulates to be deposited on the film.

Target rotor 755 rotates the target 720. The temperature of the substrate 730 was controlled and monitored by using a programmable temperature controller and pyrometer 735. When temperature is measured at the faceplate, the actual substrate temperature is expected to be lower.

The deposition rate was calibrated against the number of pulses. After deposition the chamber 760 was backfilled with oxygen from oxygen source 740 as controlled by mass flow controller 745 to near atmospheric pressure, the film was allowed to cool in the chamber at a rate of 3° C./min in presence of oxygen.

### Example 2

### Ultra Violet Assisted Pulsed Laser Deposition (UVPLD)

Conditions similar to the PLD process described in Example 1 were also employed in forming UVPLD films. A vacuum-compatible, low pressure Hg lamp with a fused silica envelope, which allows more than 85% of the emitted 184.9 nm radiation (around 6% of the 25 W output) to be transmitted, was added to the PLD system shown in FIG. 7. The lamp allows in-situ UV irradiation during the laser ablation growth process. The lamp was turned on during the deposition process. The lamp was turned off when the chamber was backfilled with oxygen and during the slow cooling process of the film (3° C./min) in oxygen. All other conditions of deposition employed remained the same as that of the PLD process described in Example 1.

It is to be understood that while the invention has been described in conjunction with the preferred specific embodiments thereof, that the foregoing description as well as the examples which follow are intended to illustrate and not limit the scope of the invention will be apparent to those skilled in the art to which the invention pertains.

We claim:

1. A cathode composition for lithium ion and lithium metal batteries, comprising:
a transitional metal oxide, said transitional metal oxide comprising a plurality of compositionally defective crystals, said defective crystals having an enhanced oxygen content as compared to a bulk equilibrium counterpart crystal.

2. The composition of claim 1, wherein said transitional metal oxide comprises a lithium manganese oxide.

3. The composition of claim 2, wherein the ratio of lithium to manganese is substantially stoichiometric.

4. The composition of claim 1, wherein said transitional metal oxide comprises Li_{1-δ}Mn_{2-2δ}O₄, wherein 0<₆<1.

5. The composition of claim 1, wherein a capacity of said cathode composition is at least 150 mAh/gm.

6. The composition of claim 1, wherein said cathode provides a Li ion diffusivity of at least 2×10₋₁₀ cm/sec at 25° C.

7. A method of forming cathode material for lithium ion and lithium metal batteries, comprising the steps of:
providing a reactive oxygen containing atmosphere, said reactive oxygen containing atmosphere comprising at least one oxygen containing species having a reactivity greater than O₂, and
ablating a transitional metal oxide material from a transitional metal containing target, wherein a plurality of compositionally defective crystals are formed, said crystals having an enhanced oxygen content as compared to said target.

8. The method of claim 7, wherein said providing step comprises supplying O₂ and applying energy to said O₂ to produce at least one oxygen containing molecule having a reactivity greater than said O₂.

9. The method of claim 7, wherein said cathode material comprises a thin film or a powder.

10. The method of claim 8, wherein said energy is provided by at least one selected from the group consisting of a UV lamp and a plasma source.

11. The method of claim 7, wherein said oxygen containing species having a reactivity greater than O₂ comprises ozone or nitrous oxide.

12. An electrochemical cell, comprising:
an anode comprising lithium ions or lithium metal;
a cathode, said cathode including a defective transitional metal oxide layer, said defective transitional metal oxide layer having an enhanced oxygen content as compared as to a bulk transitional metal oxide film, and an electrolyte operatively associated with said anode and said cathode.

13. The electrochemical cell of claim 12, wherein said transitional metal oxide comprises a lithium manganese oxide.

14. The electrochemical cell of claim 13, wherein said lithium manganese oxide comprises Li_{1-δ}Mn_{2-2-δ}O₄, wherein 0<_{δ}<1.

15. The electrochemical cell of claim 12, wherein said electrolyte includes a polymer.

16. The electrochemical cell of claim 12, wherein said cell is rechargeable.

17. The electrochemical cell of claim 12, wherein said lithium manganese oxide includes at least one doping element (M) and has the formula Li₁₋ₓM_{y}Mn_{2-2z}O₄, where x, y and z vary from 0.0 to 0.5.

18. The electrochemical cell of claim 17, wherein M is at least one selected from the group consisting of Al, Cr, Co, Ni, Mg, Ti, Ga, Fe, Ca, V and Nb.
